(19) United States
(12) Patent Application Publication
(10) Pub. No.: US 2014/0317108 A1
(43) Pub. Date: Oct. 23, 2014

(54) PRIORITIZED AND PERSONALIZED CONTENT ON ONLINE COMMUNITIES

(71) Applicant: Eunum, LLC, Roseville, MN (US)

(72) Inventors: William Howe, Chicago, IL (US); George Aris Michalopoulos, Chicago, IL (US)

(73) Assignee: Eunum, LLC, Roseville, MN (US)

(21) Appl. No.: 14/255,903

(22) Filed: Apr. 17, 2014

Related U.S. Application Data
(60) Provisional application No. 61/813,176, filed on Apr. 17, 2013.

(51) Int. Cl. G06F 17/30

(52) U.S. Cl. CPC G06F 17/30867
USPC 707/734

(57) ABSTRACT

Embodiments disclosed herein provide systems and methods that allow a member of an online community to assign personal rankings to other members of the online community to prioritize and personalize content generated by the other members of the online community to the member of the online community.

This application claims the benefit of U.S. Provisional Application No. 61/813,176, filed Apr. 17, 2013, which is hereby incorporated by reference in its entirety.

### TECHNICAL FIELD

This disclosure relates generally to systems and methods for prioritizing and personalizing content on an online community. Specifically, this disclosure relates to an online community prioritizing and personalizing content displayed to a member of the online community.

### BACKGROUND

In recent years there has been an increase in the prevalence of online communities. Online communities may give groups of like-minded users a mechanism for interacting and discussing any topic they are interested in. In response to the increase in prevalence of online communities, the amount of content associated with the online communities has increased.

Conventionally, as an example, a member of an online community may be presented with content generated by other members of the online community. The member may have the option of either being presented with all of another member's content or blocking the other member, in order to be presented with none of the other member's content. Conventionally, if the member of the online community blocks another member of the online community, the blocking member of the online community will not be presented with information associated with the blocked member, and the blocked member may no longer contact the blocking member via the online community. However, the mechanism of blocking another member in an online community may create social friction between the blocked member and the blocking member.

The mechanisms utilized by conventional online communities of either presenting members with all of another member's content or completely blocking the other member, such that the other member's content is not presented to the blocking member, is inefficient or otherwise less than desirable. Needs exist for improved systems and methods of presenting personalized and/or prioritized content to members of on an online community.

### SUMMARY

Embodiments disclosed herein provide systems and methods allowing members of an online community to determine personal rankings for other members of the online community. In response to the personalized rankings, content generated by the other members of the online community may be presented to the member of the online community in an ordered, filtered, and/or prioritized manner.

In embodiments, a first member of the online community may determine personalized rankings for other members of the online community. The personalized rankings may be based on the member actively assigning an explicit ranking to other members of the online community and/or interacting with content on the online community to passively rank the other members of the online community. The content associated with the first member's highest personalized ranking member(s) may be prominently presented to the first member of the online community. The content associated with the first member's lowest personalized ranking member(s) may be minimally presented, if presented at all, to the first member.

In embodiments, responsive to the first member's personalized rankings of the other members in the online community, a personalization module may determine the priority and placement, or lack thereof, of other members' content presented to the first member on the online community. Accordingly, different members of the online community may be presented with different content based on their personalized rankings of other members of the online community.

In embodiments, only content generated by members with a personalized ranking above a ranking threshold may be presented to the first member on the online community.

A new method for presenting and prioritizing content on an online community includes receiving content configured to be presented on an online community over a network from members of the online community, determining personalized rankings of the members of the online community for each other, including a first member's personalized rankings for each of a first group of members of the online community, wherein the personalized rankings reflect levels of interest in content produced by the ranked members, and filtering and organizing the received content for distribution and presenting the content to each member based on each member's personalized rankings of the members from whom the content was received, including presenting the content to the first member based on the first member's personalized rankings of the first group of members of the online community. Content from members of the first group who are highly ranked by the first member is presented more prominently than other content.

In implementations, the first member's personalized rankings of each of the first group of members of the online community may be based at least in part on an active ranking metric, the active ranking metric being an active metric entered by the first member on a graphical user interface associated with the online community for at least one of the first group of members of the online community. The first member's personalized rankings of each of the first group of members of the online community may be based at least in part on a passive ranking metric, the passive ranking metric being associated with the first member's interactions with the content received from the first group of members of the online community.

In implementations, the method may further include receiving data associated with a ranking threshold from the first member and filtering out from presentation to the first member content from members having personalized rankings less than the ranking threshold. The ranking threshold is associated with the first member's personalized rankings for each of the first group of members of the online community.

The first member's personalized rankings for a second group of members of the online community may be based at least in part on personalized rankings of the first group of members for the second group of members.

The first member's passive rankings for each of the first group of members may be determined at least in part by indications of approval or disapproval of the first member for content submitted by the first group of members. The indications or approval or disapproval may include explicit indications of approval and disapproval and implicit indications of approval and disapproval. The implicit indications of approval may include viewing, responding to, and sharing the content submitted by the first group of members and the implicit indications of disapproval may include quickly navigating away from the content submitted by the first group of members after viewing and responding negatively to or ignoring the content submitted by the first group of members after viewing.

In implementations, the method may further include weighting the implicit indications of approval and disapproval according to their value in predicting active rankings of the members of the online community. The implicit indications of approval and disapproval may be weighted according to their value in predicting active rankings of the members of the online community by new members of the online community and gradually the weighting may be shifted over time as the first member actively ranks the first group of members to weighting according to the value of the implicit indications of approval and disapproval in predicting active rankings of the first group of members of the online community by the first member. The implicit indications of approval and disapproval may be weighted in calculating the first member's passive rankings according to their value in predicting active rankings of the first group of members of the online community by the first member. An impact of the indications of approval or disapproval on the first member's passive rankings may be decreased over time.

The first member's passive rankings for the first group of members may be determined at least in part by a frequency of the first member's interactions with the content received from the first group of members of the online community and a greater frequency may result in a higher passive ranking. The first member's passive rankings for the first group of members may be determined at least in part by rankings of the first group of members by a second group of members ranked by the first member, such that the first member's passive rankings of the first group of members are made to be more similar to the rankings of members of the second group of members ranked highly by the first member and less similar to the rankings of members of the second group of members ranked lowly by the first member.

In implementations, the method may further include assigning default personalized rankings of the first member for the first group of members before the first member has interacted with content received from the first group of members or explicitly ranked any of the first group of members. The default rankings may be determined at least in part by average rankings of the first group of members by the members of the online community. The average rankings of the first group of members by the members on the online community may be a weighted average and the rankings of the members of the online community may be weighted by similarity of each member to the first member in demographic characteristics. The demographic characteristics used for the weighting may be determined based on the predictive value of the demographic characteristics for similarity of personalized rankings between two members. The average rankings of the first group of members by the members on the online community may be a weighted average and the rankings of the members of the online community may be weighted by similarity of each member's rankings of a second group of members to the first member's rankings of the second group of members.

The first member's personalized rankings of the first group of members of the online community may be based in part on an active ranking metric, the active ranking metric being an active metric entered by the first member on a graphical user interface associated with the online community for at least one of the first group of members of the online community, and in part on a passive ranking metric, the passive ranking metric being associated with the first member's interactions with the content received from the first group of members of the online community. The first member's personalized rankings of one or more of the first group of members may be based in part on the assigned default rankings and in part on at least one of an active ranking metric entered by the first member on a graphical user interface associated with the online community and a passive ranking metric associated with the first member's interactions with the content received from the second group of members, after the first member has explicitly ranked and/or interacted with content received from at least one member of the second group of members.

Organizing content for distribution and presenting the content to the first member may include determining an amount of content that can be presented to the first user at a given time on a graphical user interface of the online community and presenting content of the highest-ranked members that meets any thresholds of the first member and fits within the determined amount of content.

The method may further include displaying to the first member statistics relating to an average ranking of the first member by the members of the online community broken out by demographics and displaying an impact of different types and individual pieces of content submitted by the first member on the average ranking.

A new system for prioritizing and personalizing content on an online community may include a communication device configured to receive content configured to be presented on an online community over a network from members of the online community and one or more processing devices configured to execute computer program modules, the computer program modules including at least one of an active and a passive ranking module configured to determine personalized rankings of the members of the online community for each other, including a first member's personalized rankings for each of a first group of members of the online community, where the personalized rankings reflect levels of interest in content produced by the ranked members, and a presentation module configured to filter and organize the received content for distribution and present the content to each member based on each member's personalized rankings of the members from whom the content was received, including to present the content to the first member based on the first member's personalized rankings of the first group of other members of the online community, where content from members of the first group who are highly ranked by the first member is presented more prominently than other content.

In implementations, the system may include an active ranking module configured to receive an active metric entered by the first member, where the first member's personalized rankings for each of the first group of members of the online community are based at least in part on an active ranking metric, the active ranking metric being the active metric entered by the first member on a graphical user interface associated with the online community for at least one of the first group of members of the online community. The system may include a passive ranking module configured to generate a passive ranking metric, where the first member's personalized rankings for each of the first group of members of the online community are based at least in part on the passive ranking metric, the passive ranking metric being associated with the first member's interactions with the content received from the first group of members of the online community. Where active and passive rankings are combined to create a final ranking, in implementations either the active ranking module or passive ranking module or both may be configured to make the combination, or a separate combination ranking module may combine the rankings.

In implementations, the system may include a threshold module configured to receive data associated with a ranking threshold from the first member, where the ranking threshold is associated with the first member's personalized rankings for each of the first group of members of the online community, and to filter out from presentation to the first member content from members having personalized rankings less than the ranking threshold.

The first member's personalized rankings for the a second group of other members of the online community may be based at least in part on personalized rankings of the first group of members for the second group of members.

The passive ranking module may be configured to determine the first member's passive rankings for each of the first group of members at least in part by indications of approval or disapproval of the first member for content submitted by the first group of members. The indications of approval or disapproval may include explicit indications of approval and disapproval and implicit indications of approval and disapproval. The implicit indications of approval may include viewing, responding to, and sharing the content submitted by the first group of members and the implicit indications of disapproval may include quickly navigating away from the content submitted by the first group of members after viewing and responding negatively to or ignoring the content submitted by the first group of members after viewing. The passive ranking module may be configured to weight the implicit indications of approval and disapproval according to the value of the indications of approval and disapproval in predicting active rankings of the members of the online community. The passive ranking module may be configured to weight the implicit indications of approval and disapproval according to their value in predicting active rankings of the members of the online community by new members of the online community and to gradually shift the weighting over time as the first member actively ranks the first group of members to weighting according to the value of the implicit indications of approval and disapproval in predicting active rankings of the first group of members of the online community by the first member. The passive ranking module may be configured to weight the implicit indications of approval and disapproval in calculating the first member's passive rankings according to their value in predicting active rankings of the first group of members of the online community by the first member. The passive ranking module may be configured to decrease an impact of the indications of approval or disapproval on the first member's passive rankings over time.

The passive ranking module may be configured to determine the first member's passive rankings for the first group of members at least in part by a frequency of the first member's interactions with the content received from the first group of members of the online community and a greater frequency may result in a higher passive ranking.

The passive ranking module may be configured to determine the first member's passive rankings for the first group of members at least in part by rankings for the first group of members by a second group of members ranked by the first member, such that the first member's passive rankings for the first group of members are made to be more similar to the rankings of members of the second group of members ranked highly by the first member and less similar to the rankings of members of the second group of members ranked lowly by the first member.

The system may further include an aggregation module configured to assign default personalized rankings of the first member for the first group of members before the first member has interacted with content received from the first group of members or explicitly ranked any of the first group of members, and to determine the default rankings at least in part by average rankings of the first group of members by the members of the online community. The first member's personalized rankings of the first group of members of the online community may be based in part on an active ranking metric, the active ranking metric being an active metric entered by the first member on a graphical user interface associated with the online community for at least one of the first group of members of the online community, and in part on a passive ranking metric, the passive ranking metric being associated with the first member's interactions with the content received from the first group of members of the online community. The first member's personalized rankings of one or more of the first group of members may be based in part on the assigned default rankings and in part on at least one of an active ranking metric entered by the first member on a graphical user interface associated with the online community and a passive ranking metric associated with the first member's interactions with the content received from the second group of members, after the first member has explicitly ranked and/or interacted with content received from at least one member of the second group of members. The average rankings of the first group of members by the members on the online community may be a weighted average and the aggregation module may be configured to weight the rankings of the members of the online community by similarity of each member to the first member in demographic characteristics. The aggregation module may be configured to weight the demographic characteristics used based on their predictive value for similarity of personalized rankings between two members. The average rankings of the first group of members by the members on the online community may be a weighted average and the aggregation module may be configured to weight the rankings of the members of the online community by similarity of each member's rankings of a second group of members to the first member's rankings of the second group of members.

In implementations, the presentation module may be configured to determine an amount of content that can be presented to the first user at a given time on a graphical user interface of the online community and present content of the highest-ranked members that meets any thresholds of the first member and fits within the determined amount of content. The presentation module may be further configured to display to the first member statistics relating to an average ranking of the first member by the members of the online community broken out by demographics and display an impact of different types and individual pieces of content submitted by the first member on the average ranking.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts an embodiment of a network topology for personalizing and prioritizing content presented to members of an online community.

FIG. 2 depicts an embodiment of a personalization module to personalize and prioritize content presented to members of an online community.

FIG. 3 depicts an embodiment of a method for personalizing and prioritizing content presented to a member of an online community.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). The terms “first member” and “second member” as used herein are intended only to differentiate between various members of an online community, and are not intended to have a chronological or ordinal connotation.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

Embodiments disclosed herein provide systems and methods allowing members of an online community to determine personal rankings for other members of the online community to prioritize and personalize content generated by the other members of the online community that is presented to the member of the online community.

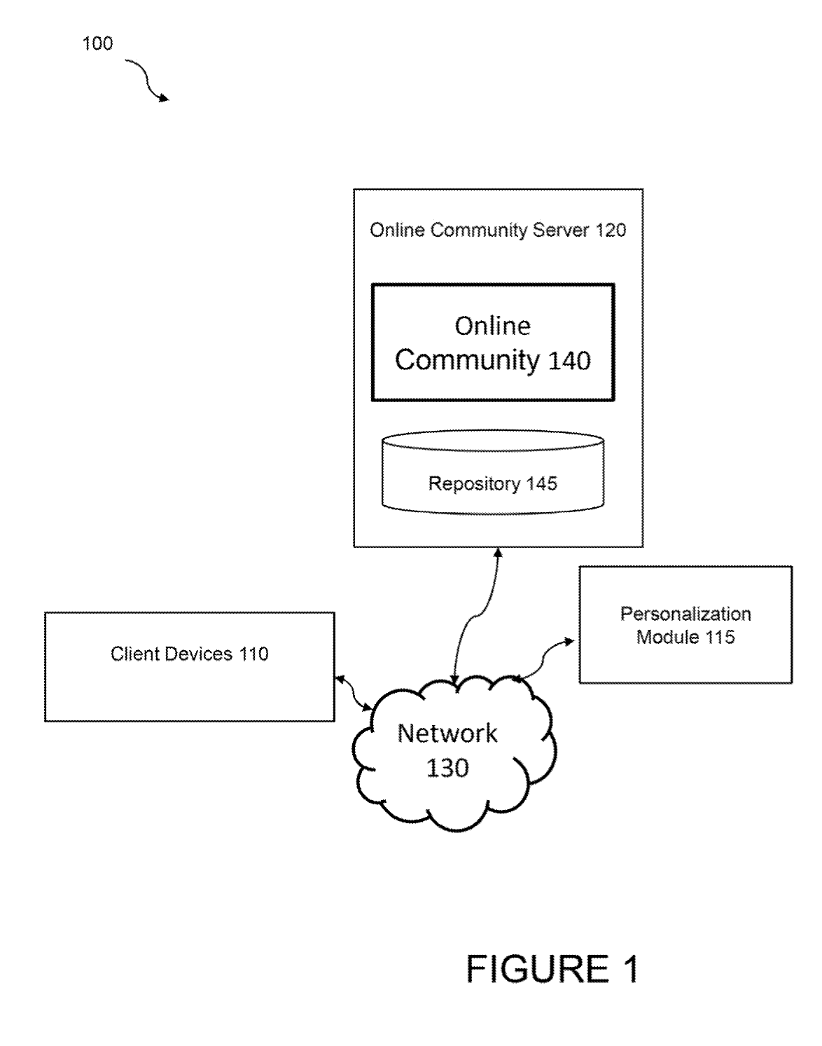

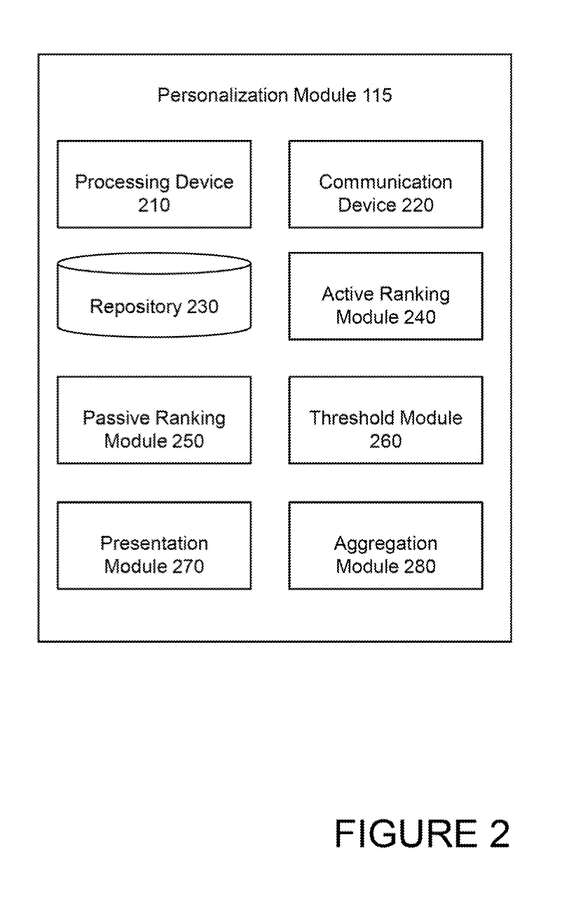

FIG. 1 depicts one embodiment of network topology 100 for personalizing and prioritizing content for a member of an online community. The topology 100 includes one or more client devices 110 connected to personalization module 115 and an online community server 120 over a network 130. In some embodiments, personalization module 115 may reside on online community server 120 or on a third-party server or servers. In some embodiments, some elements of personalization module 115 (as shown for example in FIG. 2) may reside on online community server 120 and others may reside on a third-party server or servers. In some embodiments, some elements of personalization module 115 may reside on client devices 110 as a downloaded app or similar.

The network 130 may be a wired or wireless network such as the Internet, an intranet, a LAN, a WAN, a cellular network or another type of network. It will be understood that network 130 may be a combination of multiple different kinds of wired or wireless networks.

Online community server 120 may be a server (or multiple servers, e.g. a cloud server) that is capable of supporting an online community 140, and may be communicatively coupled to client devices 110 and personalization module 115 via network 130. Online community server 120 may include a processor, memory, and interface configured to communicate data to and from client devices 110. Some non-limiting specific examples of online communities 140 may include the micro-blogging service provided by Twitter®, the social network provided by Facebook®, the social network provided by MySpace®, the social network provided by Foursquare®, the file sharing service provided by Flickr®, Blogger, YouTube®, PlayStation® Home, Xbox® Live, and/or other interactive electronic social media. Online community 140 may be associated with any genre, topic or sub-topic and may include groups of users interested in subject matter associated with the group, and may be a website by itself or may be a subset of a website.

One skilled in the art will realize that online community 140 does not have to be associated with a particular topic or subject and may have members that are not associated with each other. In embodiments, a member of online community 140 may generate content to be presented to other members of online community 140. Members of online community 140 may interact with each other through communications exchanged within online community 140 and by transmitting content received by online community server 120 that may be presented to members of online community 140. Such communications may include one or more of textual chat, instant messages, private messages, voice communications, and/or other communications. Generated content for online community 140 may be links, posts, comments, blogs, articles, videos, images, and/or any other type of content a member may transmit to online community 140 via computing device 110. Communications and content may be received by online community server 120 from members via their respective client devices 110. In embodiments, online community server 120 may include repository 145. Repository 145 may be a file store, memory, or some other storage medium configured to store components (e.g. modules, instructions, etc.) to support online community 140, and may store communications and member-generated content and/or any other form of data for online community 140.

Client devices 110 may be smart phones, laptop computers, desktop computers, tablets, netbooks, personal data assistants (PDA) and/or any other type of device that can process instructions and connect to network 130 or one or more portions of network 130. Client devices 110 may have a processor, memory, display, and/or interface configured to receive inputs from an end user. A member of online community 140 may use client device 110 to transmit member-generated content such as an article, post, image, movie, audio recording, etc. to online community server 120. The transmitted content may be configured to be rendered on an interface for online community 140 so other members associated with online community 140 may view the content. In further embodiments, members of online community 140 may generate comments, edit, re-publish, or perform other actions associated with the content for online community 140, which may be transmitted via client device 110.

Personalization module 115 may be configured to prioritize and/or filter content presented to a member of online community 140. Personalization module 115 may allow members to control what member-generated content is presented to them without necessarily blocking other members of online community 140. Personalization module 115 may be configured to determine a first member's personalized ranking for other members of online community 140, without the other members of the online community having knowledge of their rankings associated with the first member. Responsive to the first member's personalized ranking of other members of online community 140, the placement and priority of the content may be adjusted and the content may be presented to the first member of online community 140.

In embodiments, personalization module 115 may be configured to receive active rankings, such as numerical rankings, of other members of online community 140 from the first member of online community 140 through client device 110. In embodiments, personalization module 115 may also or alternatively be configured to determine passive rankings of other members of the online community based on the first member's interactions with content on online community 140 via client device 110. For example, personalization module 115 may determine the first member's personalized rankings of other members of online community 140 in response to the first member's commenting on, approving, clicking, sharing, copying, etc. another member's generated content on online community 140.

Passive rankings may also be based on the member rankings of members the first member has ranked. For example, if the first user rates a second member highly, and the second member rates a third member highly (or low), the third member may be assigned a high (or low) passive ranking with the first member as well. In such instances, the ranking assigned to the third member may be regressed towards zero, so that if the ranking of the third member by the second member is very high, the ranking of the third member assigned to the first member may be not as high. The influence of the second member's ranking of the third member on the first member's ranking of the third member may be determined in part by the ranking of the second member by the first member. For example, if the second member is ranked very highly or very poorly by the first member, the second member's own rankings may be very influential on the first member's rankings of other members (either positively or negatively), while if the second member is ranked only slightly higher than average or slightly lower than average, that second member's rankings may have little or no effect on the first member's rankings. In some embodiments, the first member's personalized rankings of other members of online community 140 may be based on a combination of the first member's active and passive rankings of other members of online community 140.

Actions indicating approval of another member's content such as viewing, responding to, and sharing the other member's content, for example, may be an indication that the user taking the action rates the other member highly. Actions of downvoting or otherwise disapproving the other member's content, quickly navigating away from the user's content after viewing, and/or responding negatively to or ignoring the other user's content after viewing, for example, may indicate that the user taking the action ranks the other member lowly. The impact of each action may vary. For example, viewing another member's content for a modest length of time may suggest a slightly higher than normal/default ranking, whereas sharing the other member's content may suggest a much higher than normal ranking.

Personalization module 115 may base the first member's personalized rankings of other members of online community 140 on the frequency with which the first member interacts with or performs certain actions with respect to the other members' content on online community 140 over a period of time. In some embodiments, certain actions taken by the first member with respect to another member's content may increment or decrement the first member's ranking for that other member by a given amount. The amount may not scale linearly with frequency, so indicating approval of one of a second member's posts in a day may increment the first member's ranking of the second member by one level, while indicating approval of three of the second member's posts in a day may for example increment the first member's ranking of the second member by five levels (or conversely only by two levels). The amount of the increment or decrement may also fade over time. For example, the first member approving another member's content may initially increment the first member's ranking of the other member by five levels, decreasing by one level for every week after the initial approving action, until the increment falls to zero. This may help to reflect the first member's changing attitude towards another member.

Moving now to FIG. 2, one embodiment of a network topology 200 for personalizing and prioritizing content for a member of an online community is depicted. Certain elements of topology 200 may be similar to those depicted in FIG. 1, therefore another description of these elements is omitted for the sake of brevity.

As depicted in FIG. 2, personalization module 115 may include processing device 210, communication device 220, repository 230, an active ranking module 240, a passive ranking module 250, a threshold module 260, a presentation module 270, and an aggregation module 280.

Processing device 210 may include memory, e.g., read only memory (ROM) and random access memory (RAM), storing processor-executable instructions and one or more processors that execute the processor-executable instructions. In embodiments where processing device 210 includes two or more processors, the processors may operate in a parallel or distributed manner. In the illustrative embodiment, processing device 210 may execute and/or process data associated with communication device 220, repository 230, active ranking module 240, passive ranking module 250, threshold module 260, and/or presentation module 270. Processing devices 210 may be configured to execute computer program modules.

Communication device 220 may be a device that allows personalization module 115 to communicate with other devices, e.g., the computing device 110 and/or online community server 120, via network 130. Communication device 220 may include one or more wireless transceivers for performing wireless communication and/or one or more communication ports for performing wired communication. In one embodiment, communication device 220 may be configured to receive pieces of content generated by members of the online community. Communication device 220 may be configured to receive content configured to be presented on an online community over a network from members of the online community. Responsive to receiving a piece of content, processing device 210 may tag the piece of content with an identifier identifying which member of the online community transmitted the piece of content. In embodiments, the identifier may be a username of the member for the online community, an email address of the member, and/or any other unique identifier for the member.

Repository 230 may be a memory device that stores data and/or content generated or received by personalization module 115. In embodiments, a piece of content stored within repository 230 may be linked with the identifier for the member of the online community that transmitted the piece of content. Repository 230 may include, but is not limited to a hard disc drive, an optical disc drive, and/or a flash memory drive. In embodiments, repository 230 may also be configured to store data associated with a member of the online community's personalized rankings of other members of the online community. In embodiments, processing device 210 may sort the pieces of content stored within repository 230 based on the member's personalized rankings of other members of the online community. In embodiments, the member's personalized rankings may be based on active ranking metrics and passive ranking metrics for the other members of the online community, where the active ranking metrics and the passive ranking metrics may be weighted evenly or differently to determine the personalized rankings A first member's personalized rankings of a first group of members of the online community may be based in part on an active ranking metric, the active ranking metric being an active metric entered by the first member on a graphical user interface associated with the online community for at least one of the first group of members of the online community, and in part on a passive ranking metric, the passive ranking metric being associated with the first member's interactions with the content received from the first group of members of the online community.

Active ranking module 240 may be configured to determine an active ranking metric for other members of an online community for a first member of the online community. In embodiments, the active ranking metric may be any metric, such as a numerical range (i.e., 1 to 10, 1 to 100, etc.), an alphabetical range (i.e., A-Z), or phrases (i.e., private, public, general, high, low, average, etc.). Accordingly, one skilled in the art will appreciate that the active ranking metric may be any recordable metric, range, and/or series.

The first member's active ranking metric for other members of the online community may be based on the first member performing an interaction in the online community to set other members' active ranking metric. For example, the first member of the online community may enter information associated with the active ranking metric for a second member of the online community on a user interface of the online community. In one embodiment, the first member may enter an active ranking of 10, which may be the highest assignable active ranking metric, for the second member of the online community. The second member's generated content on the online community may be prominently featured and presented to the first member of the online community responsive to the high active ranking metric. For example, if the second member generated content for the online community, the generated content would be prominently presented to the first member on the online community when navigating to the online community e.g. via a web browser. In one embodiment, the first member may enter an active ranking of 1, which may be the lowest assignable active ranking metric, to a third member of the online community. The third member's generated content on the online community may be minimally featured and presented to the first member of the online community responsive to the low active ranking metric. For example, if the third member generated content for the online community, the generated content would not likely be presented to the first member on the online community, or the first member might have to scroll to the bottom of a webpage of the online community or the bottom of the last of a number of webpages of content before that third member's content is displayed.

The active ranking module may be configured to determine personalized rankings of the members of the online community for each other, by itself and/or in combination with the passive ranking module, including a first member's personalized rankings for each of a first group of members of the online community. The personalized rankings reflect levels of interest in content produced by the ranked members.

The active ranking module may be configured to receive an active metric entered by the first member, wherein the first member's personalized rankings of each of the other first group of members of the online community are based at least in part on an active ranking metric, the active ranking metric being the active metric entered by the first member on a graphical user interface associated with the online community for at least one of the first group of other members of the online community.

Passive ranking module 250 may be configured to determine a first member's passive ranking metric for other members of an online community based on the first member's interactions with other members' content on the online community. In one embodiment, the passive ranking metric may be based on the frequency with which the first member indicates approval of, comments on, votes on, clinks on, shares, copies, etc. other members' content on the online community. In embodiments, the passive ranking metric may be any metric, such as a numerical range (i.e., 1 to 10, 1 to 100, etc.), an alphabetical range (i.e., A-Z), or phrases (i.e., private, public, general, high, low, average, etc.). Accordingly, one skilled in the art will appreciate that the active ranking metric may be any recordable metric, range, and/or series. In embodiments, the passive ranking metric may the same metric as the active ranking metric or the passive ranking metric may be a different metric than the active ranking metric.

The passive ranking metric for other members of the online community may also be based in part or in whole on the first member's frequency of interactions with other members' content on the online community. For example, the first member's passive ranking metric of other members of the online community may be based on a total number of interactions that the first member had with the other members' content on the online community over a day, week, year, etc. For example, each time the first member interacts with a piece of content generated by a second member, the first member's passive ranking of the second member may be increased incrementally. If the first member of the online community frequently interacts with content generated by the second member of the online community, the first member's passive ranking metric for the second member may be higher than members of the online community whose content the first member has minimal interactions with. As a result, the second member's generated content on the online community may be prominently featured and presented to the first member of the online community. In one embodiment, the first member may not interact with a third member's content on the online community. Accordingly, the third member's generated content on the online community may be minimally featured and presented to the first member of the online community. In some such embodiments, no discrimination may be made between positive and negative interactions. For example, a first member may dislike a second member and the content the second member generates, but nevertheless frequently comment on the second member's content in order to attack it, explain why it is wrong, debunk it, etc. The first user may want to be presented with the second member's content in order to have the opportunity to, for example, prevent it from convincing other members of what the first member considers an incorrect belief. Thus, the second member's content would be displayed to the first member prominently despite the first user consistently downvoting and otherwise disapproving of the content. In other embodiments, discrimination is made between positive interactions and negative interactions such as argumentative comments/criticism, downvoting, and the like.

The passive ranking module may be configured to generate a passive ranking metric. The first member's personalized rankings for of each of the first group of members of the online community may be based at least in part on the passive ranking metric, the passive ranking metric being associated with the first member's interactions with the content received from the first group of members of the online community. The first member's personalized rankings for a second group of members of the online community may be based at least in part on personalized rankings of the first group of members for the second group of members.

The passive ranking module may be configured to determine the first member's passive rankings for each of the first group of members at least in part by indications of approval or disapproval of the first member for content submitted by the first group of members. The indications or approval or disapproval may include explicit indications of approval and disapproval and implicit indications of approval and disapproval. The implicit indications of approval may include viewing, responding to, and sharing the content submitted by the first group of members and the implicit indications of disapproval may include quickly navigating away from the content submitted by the first group of members after viewing and responding negatively to or ignoring the content submitted by the first group of members after viewing.

The passive ranking module may be configured to weight the implicit indications of approval and disapproval according to the value of the indications of approval and disapproval in predicting active rankings of the members of the online community. The passive ranking module may be configured to weight the implicit indications of approval and disapproval according to their value in predicting active rankings of the members of the online community by new members of the online community and to gradually shift the weighting over time as the first member actively ranks the first group of members to weighting according to the value of the implicit indications of approval and disapproval in predicting active rankings of the first group of members of the online community by the first member. The passive ranking module may be configured to weight the implicit indications of approval and disapproval in calculating the first member's passive rankings according to their value in predicting active rankings of the first group of members of the online community by the first member. The passive ranking module may be configured to decrease an impact of the indications of approval or disapproval on the first member's passive rankings over time.

The passive ranking module may be configured to determine the first member's passive rankings for the first group of members at least in part by a frequency of the first member's interactions with the content received from the first group of members of the online community and a greater frequency may result in a higher passive ranking. The passive ranking module may be configured to determine the first member's passive rankings for the first group of members at least in part by rankings of the first group of members by a second group of members ranked by the first member, such that the first member's passive rankings of the first group of members are made to be more similar to the rankings of members of the second group of members ranked highly by the first member and less similar to the rankings of members of the second group of members ranked lowly by the first member.

Aggregation module 280 may be configured to analyze active and/or passive rankings from multiple members to make determinations as to how member-submitted content should be filtered and/or displayed for certain users, groups of users, or the entire online community. For example, for members who have not yet actively and/or passively ranked a given member, a default ranking may be assigned for that given member based on the rankings assigned by other members. This default ranking may be, for example, simply the average active ranking, passive ranking, or some weighted average of active and passive rankings, assigned to the given member by members who have assigned the given member a ranking. Thus, the content of the most highly ranked members is given top billing by default and is what new members of the online community will first see. As a new member starts to rank these members, the rankings may be adjusted from the default rankings assigned, or may adjust to be based only on the ranking actions by the new member and not on rankings assigned by other members, or may adjust over time from being strongly influenced by rankings of other members to being less or not at all influenced thereby.

In some embodiments, the effect of other members' rankings on a member's rankings may vary depending on information known about the member, such as demographic information, what site(s) the member arrived at the online community from, geographic location, what other members the member is associated with or interacts with, other online communities the member frequents, browser and/or other computing software and hardware used, etc. For example, the online community may customize displayed content if it determines that a visitor is from a given geographic location, for examples using an IP address lookup. For example, for a new member from the U.S., content of the members most highly ranked by other U.S. members may be prioritized. For a new member using a Safari browser, or Internet Explorer browser, content from members highly ranked by other Safari-users or other Internet Explorer-users may be prioritized. More weight may be given to rankings of other members a new member frequently interacts with or is associated with in some way (such as being friends with the other user on a social network).

The characteristics across which members are compared for this purpose may be data-driven, based on what characteristics are predictive of shared content preferences. For example, if statistically speaking members who share a region of residence have similar rankings of other members, the rankings of other members who share the same region of residence may be given more weight in determining a first member's initial default rankings. If gender statistically has no such predictive power, other members rankings will not be weighted more highly just because they are the same gender as the first member. As the first member begins ranking other members, actively and/or passively, the weight given to these statistically identified predictive characteristics may be lessened, and more weight may be given to the rankings of other members who agree with the first member's rankings to date. For example, if the first user now actively ranks five other members, the first member's default rankings for other members than those actively ranked may depend heavily on the rankings of those other members by members who share the first user's rankings of the five other members. Simple statistics can be used to determine when a first member's rankings are similar enough to a second member's rankings that the first member's rankings of members unranked by the second user become predictive of what the second user will rank those members to a given degree of confidence. As predictiveness increases, the weight given to those members' rankings may grow. After sufficient rankings have been entered by the first member, the rankings of other members with similar rankings may be the primary basis for the first member's default rankings for other members.

The aggregation module may be configured to assign default personalized rankings of the first member for the first group of members before the first member has interacted with content received from the first group of members or explicitly ranked any of the first group of members, and to determine the default rankings at least in part by average rankings of the first group of members by the members of the online community. The average rankings of the first group of members by the members on the online community may be a weighted average and the aggregation module may be configured to weight the rankings of the members of the online community by similarity of each member to the first member in demographic characteristics. The aggregation module may be configured to weight the demographic characteristics used based on their predictive value for similarity of personalized rankings between two members. The average rankings of the first group of members by the members on the online community may be a weighted average and the aggregation module may be configured to weight the rankings of the members of the online community by similarity of each member's rankings of a second group of members to the first member's rankings of the second group of members.

The first member's personalized rankings of one or more of the first group of members may be based in part on the assigned default rankings and in part on at least one of an active ranking metric entered by the first member on a graphical user interface associated with the online community and a passive ranking metric associated with the first member's interactions with the content received from the second group of members, after the first member has explicitly ranked and/or interacted with content received from at least one member of the second group of members.

Threshold module 260 may be configured to filter content presented to the first member of the online community based on the first member's active ranking metric, passive ranking metric, and/or a combination ranking metric. The combination ranking metric may be based on the weighted active ranking metric and/or passive ranking metric. In embodiments, the combination ranking metric may be comprised of an average of the active ranking metric and the passive ranking metric or varying weights given to the active ranking metric and the passive ranking metric. In embodiments, threshold module 260 may include an active ranking threshold, a passive ranking threshold, and/or a combination ranking threshold associated with the first member's active ranking metric, passive ranking metric, and combination ranking metric, respectively. The threshold module may be configured to receive data associated with a ranking threshold from the first member, wherein the ranking threshold is associated with the first member's personalized rankings for each of the other first group of members of the online community, and to filter out from presentation to the first member content from members having personalized rankings less than the ranking threshold.

In embodiments, threshold module 260 may receive data from the first member operating a client device indicating an active ranking threshold, passive ranking threshold, and/or a combination ranking threshold (referred to hereinafter individually and collectively as “ranking threshold”) associated with what content the first member desires to be presented with. For example, threshold module 260 may receive data indicating that the first member desires to be presented with content from members of the online community with an active ranking metric being greater than or equal to eight. Accordingly, threshold module 260 may filter content and not present content to the first member from other members with an active ranking metric less than the active ranking threshold. Similarly, threshold module 260 may receive data from the first member regarding the passive ranking threshold and/or the combination threshold to be used to filter content presented to the first member of the online community.

In further embodiments, threshold module 260 may receive information from the first member to set an active ranking range, passive ranking range, or a combination ranking range for content that the first member is presented with. For example, the first member may set an active ranking range indicating a desire to be presented with content from members with an active ranking metric of exactly six. Accordingly, only the content of members with an active ranking metric of six may be presented to the first member.

Presentation module 270 may be configured to present content on the online community to the first member. Presentation module 270 may present content on the online community to the first member in response to the active ranking metric, the passive ranking metric, and/or the combination metric (referred to herein after individually or collectively as “personalized rankings”), and/or their associated thresholds. The presentation module may be configured to filter and organize the received content for distribution and present the content to each member based on each member's personalized rankings of the members from whom the content was received, including to present the content to the first member based on the first member's personalized rankings of the first group of other members of the online community Content from members of the first group who are highly ranked by the first member may be presented more prominently than other content.

Presentation module 270 may also determine what content to present to the first user in response to how many pieces of content and/or how much total content can be presented to the first user at any given time on a graphical user interface of the online community. For example, the online community may be formatted to present twelve pieces of content on the graphical user interface to the first member at a given time. If there are more than twelve pieces of content available to be presented to the first member, then the twelve pieces of content submitted by the members with the first member's highest personalized rankings may be presented to the first member and the others may be left off the graphical user interface. In some embodiments, a web page is formatted to allow for the presentation of a certain number n of pieces of content at one time on a member's display, with new pieces of content being displayed as a member scrolls down and content at the top removed accordingly. In such embodiments, certain pieces of content may be loaded for a member, with only the top-ranked n pieces displayed on the graphical user interface, but additional loaded pieces of content are displayed as a member scrolls down, to replace those at the top that fall off the graphical user interface.

Presentation of content may also depend on other factors such as age/freshness of content, which may be weighted in various ways with the rankings of the members supplying the content. For example, the displayed content may drop off the presented page and be replaced by newer content after a certain period of time passes such as a day. Alternatively, more highly ranked content may take more time to drop off than other content, at least until it has been read or otherwise interacted with by the member. For example, the content might drop off after a number of days equal to the ranking of the member that submitted it.

In one embodiment, the first member may set a ranking threshold providing that content from members with a personalized ranking of seven or higher be given priority over content generated by members with a lower personalized ranking. Accordingly, the content of members with a ranking of seven or higher would take priority and be presented on the online community to the first member before any content from members with personalized rankings below a seven are presented to the first member. For example, the online community may be configured to present twelve pieces of content to the first member. Further, the online community may have fifteen pieces of member-generated content available and fourteen of those pieces of content may be generated by members with a personalized ranking higher than seven and one piece of content may be generated by a member with a personalized ranking lower than seven. The piece of content generated by the member with the personalized ranking lower than seven may not be presented to the first member. In a further embodiment, if there were fifteen pieces of member generated content to be presented on the online community but only nine of those pieces of content were generated by members with a personalized ranking higher than a ranking threshold, then the nine pieces of content generated by members with a personalized ranking higher than the ranking threshold would be presented to the first member, and three pieces of content generated by members with a personalized ranking lower than the ranking threshold would not be presented to the first member.

The presentation module may be configured to determine an amount of content that can be presented to the first user at a given time on a graphical user interface of the online community and present content of the highest-ranked members that meets any thresholds of the first member and fits within the determined amount of content. The presentation module may be configured to display to the first member statistics relating to an average ranking of the first member by the members of the online community broken out by demographics and display an impact of different types and individual pieces of content submitted by the first member on the average ranking.

The description of the functionality provided by the different modules 240, 250, 260, 270 and 280 is for illustrative purposes, and is not intended to be limiting, as any of modules 240, 250, 260, 270 and 280 may provide more or less functionality than is described. For example, one or more of modules 240, 250, 260, 270 and 280 may be eliminated, and some or all of its functionality may be provided by other ones of modules 240, 250, 260, 270 and 280. As another example, the Processing Device 210 may be configured to execute one or more additional modules that may perform some or all of the functionality attributed below to one of modules 240, 250, 260, 270 and 280. Other functionality described with respect to FIGS. 1 and 2 and not explicitly indicated as being performed by one or more of modules 240, 250, 260, 270 and 280 may nevertheless be performed by one or more of those modules, or by other modules not expressly disclosed.

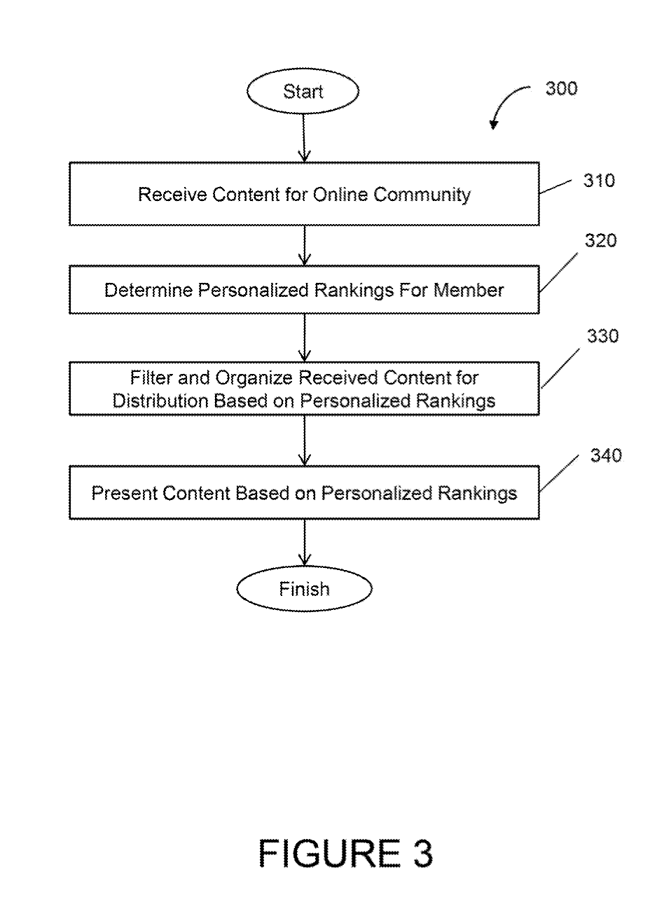

FIG. 3 depicts an embodiment of a method 300 for presenting content to a member of an online community responsive to a member's personalized ranking of other members of the online community. The steps of method 300 presented below are intended to be illustrative. In some embodiments, method 300 may be accomplished with one or more additional steps that are not described below, and/or without one or more of the steps described below. Additionally, the order in which the steps of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the steps of method 300 in response to instructions stored electronically on an electronic storage medium. The one or more processing devices may include one or more devices configured through hardware, firmware, and/or software to be specifically designed for execution of one or more of the steps of method 300.

At step 310, an online community may receive content to be presented to members of the online community. The content may be received from members of the online community and be configured to be presented over a network. The content may be stored in a repository along with an identifier identifying the member of the online community that generated and transmitted the received piece of content for the online community. Step 310 may be performed by a communication device that is the same as or similar to communication device 220, in accordance with one or more embodiments.

At step 320, personalized rankings of the members of the online community for each other may be determined, including a first member's personalized rankings for each of a first group of members of the online community. The personalized rankings may reflect levels of interest in content produced by the ranked members. The first member's personalized rankings of other members of the online community may be based on an active ranking metric and/or a passive ranking metric. The first member's personalized rankings of the first group of members of the online community may be based in part on an active ranking metric and in part on a passive ranking metric. The active ranking metric may be responsive to the first member actively submitting a ranking of other members of the online community, and the passive ranking metric may be responsive to the first member's interactions with pieces of content on the online community received from the first group of members. The active ranking metric may be an active metric entered by the first member on a graphical user interface associated with the online community for at least one of the first group of members of the online community.

The first member's personalized rankings for a second group of members of the online community may based at least in part on personalized rankings of the first group of members for the second group of members. The first member's passive rankings for each of the first group of members may be determined at least in part by indications of approval or disapproval of the first member for content submitted by the first group of members. The indications or approval or disapproval may include explicit indications of approval and disapproval and/or implicit indications of approval and disapproval. The implicit indications of approval may include viewing, responding to, and sharing the content submitted by the first group of members and the implicit indications of disapproval may include quickly navigating away from the content submitted by the first group of members after viewing and responding negatively to or ignoring the content submitted by the first group of members after viewing. The implicit indications of approval and disapproval may be weighted according to their value in predicting active rankings of the members of the online community. The implicit indications of approval and disapproval may be weighted according to their value in predicting active rankings of the members of the online community by new members of the online community and the weighting may be gradually shifted over time as the first member actively ranks the first group of members to weighting according to the value of the implicit indications of approval and disapproval in predicting active rankings of the first group of members of the online community by the first member. The implicit indications of approval and disapproval may be weighted in calculating the first member's passive rankings according to their value in predicting active rankings of the first group of members of the online community by the first member. An impact of the indications of approval or disapproval on the first member's passive rankings may be decreased over time.

The first member's passive rankings for the first group of members may be determined at least in part by a frequency of the first member's interactions with the content received from the first group of members of the online community and a greater frequency may result in a higher passive ranking. The first member's passive rankings for the first group of members may be determined at least in part by rankings of the first group of members by a second group of members ranked by the first member, such that the first member's passive rankings of the first group of members are made to be more similar to the rankings of members of the second group of members ranked highly by the first member and less similar to the rankings of members of the second group of members ranked lowly by the first member.

Default personalized rankings of the first member for the first group of members may be assigned before the first member has interacted with content received from the first group of members or explicitly ranked any of the first group of members. The default rankings may be determined at least in part by average rankings of the first group of members by the members of the online community. The first member's personalized rankings of one or more of the first group of members may be based in part on the assigned default rankings and in part on at least one of an active ranking metric and a passive ranking metric. The average rankings of the first group of members by the members on the online community may be a weighted average and the rankings of the members of the online community may be weighted by similarity of each member to the first member in demographic characteristics. The demographic characteristics used for the weighting may be determined based on the predictive value of the demographic characteristics for similarity of personalized rankings between two members. The rankings of the members of the online community may be weighted by similarity of each member's rankings of a second group of members to the first member's rankings of the second group of members.

Step 320 may be performed by an active ranking module and/or a passive ranking module which may be the same as or similar to active ranking module 240 and/or passive ranking module 250, in accordance with one or more embodiments.

At step 330, the pieces of content submitted by the other members of the online community may be filtered and organized for distribution based on each member's personalized rankings of the members from whom the content was received. The pieces of content may be filtered and organized for distribution based on the first member's personalized rankings for the other members of the online community. For example, content from members below a certain ranking may be filtered out of content for distribution to the first member, while remaining content may be organized for distribution to the first member based on the first member's rankings of the members who contributed the content. Data associated with a ranking threshold may be received from the first member, and the ranking threshold may be associated with the first member's personalized rankings for each of the first group of members of the online community. Content from members having personalized rankings less than the ranking threshold may be filtered out from presentation to the first member. In embodiments, the first member's personalized rankings may be based on the first member's active ranking metrics and passive ranking metrics for the other members of the online community, where the active ranking metrics and the passive ranking metrics may be weighted evenly or differently. Step 330 may be performed by a processing device that is the same as or similar to processing device 210, and/or a threshold module which may be the same as or similar to threshold module 260, in accordance with one or more embodiments.

At step 340, the content received by the online community from the members of the online community may be presented to each member of the online community based on each member's personalized rankings of the members from whom the content was received, including presenting the content to the first member based on the first member's personalized rankings of the first group of members of the online community. Content from members of the first group who are highly ranked by the first member may be presented more prominently than other content. The content may be presented to the first member of the online community based on the first member's personalized rankings of the other members of the online community and a number of pieces of content configured to be presented to the first member on a graphical user interface of the online community. An amount of content that can be presented to the first user at a given time on a graphical user interface of the online community may be determined and content of the highest-ranked members that meets any thresholds of the first member and fits within the determined amount of content may be presented. In embodiments, the content presented to the first member may be received from members of the online community having the first member's highest personalized rankings.

Statistics relating to an average ranking of the first member by the members of the online community may be displayed to the first member broken out by demographics and displaying an impact of different types and individual pieces of content submitted by the first member on the average ranking Step 340 may be performed by a presentation module that is the same as or similar to presentation module 270, in accordance with one or more embodiments.

### Exemplary Implementation

For clarity, an exemplary implementation of the disclosed system will be described in detail. An online forum has registered members who have selected unique usernames and have submitted other information about themselves for administrative and/or profile purposes, including their email addresses. The forum allows the members to make posts under their username and to interact with the posts in various ways, including clicking on the title of a post to read the full post, commenting on the posts, indicating approval or disapproval, and sharing the posts. Each post is associated with the user that submitted it, displaying the username next to the title of the post in the forum.

The forum also has a feature allowing members to submit explicit 1-10 rankings of other members, with an explanation that ranking a member highly will result in that member's posts being displayed more prominently and ranking a member low will result in that member's posts being displayed less prominently. A member may, for example, click on another member's username next to a post submitted by that member in the forum, and a webpage with that member's profile and recent contributions (posts and comments) may be displayed along with a box for submitting a ranking of that member.

Members further have an option that can be set from their profile to turn on or off passive rankings. When turned on, passive rankings are generated based on each member's interactions with other members' contributions, including clicking on a post title to view the full post, commenting on or sharing the post, indicating approval or disapproval of the post, and spending time reading the post and comments regarding the post. Passive rankings are also based on ranked members' rankings of other members (for example, member A rates member B highly, and member B ranks member C highly, and as a result, A has a high passive ranking for member C). In this way, rankings may be calculated without any explicit action on the member's part. The impact of each type of interaction on a member's passive ranking is determined according to its value in predicting active rankings of the members of the forum. In this forum, statistically sharing a post and indicating explicit approval (or disapproval) of a post are most correlated to high (low) active rankings, and therefore have the most influence on passive rankings, while viewing a post has a low correlation with high active rankings and therefore has only a small influence on the passive rankings.

In this forum, when passive rankings are turned on they affect the prominence with which other members' contributions are displayed to the ranking member, even if that member has also provided an active ranking of the same members. The passive rankings initially serve to distinguish between members with the same active ranking, and the influence of the passive rankings versus the active rankings grows as time passes since the active ranking was last explicitly made, up to a maximum of two full ranking grades (e.g. passive rankings can effectively change an active ranking from a six to a four or an eight, but no more). For example, a member C actively ranks a member D as a six. However over the course of a couple of years member C interacts frequently with member D's contribution and indicates by approval and sharing that member D is a strong favorite of member C. Thus member D's effective ranking becomes an eight and member D's contributions are presented to member C with corresponding prominence. This recognizes that members may not frequently update their active rankings and may lose track of what they have ranked other members.

The forum has a webpage on which forum posts are displayed to members. The page displays up to 30 posts by title and username, and additional posts further down the list can be viewed by a member selecting a “next page” option. Members may toggle between two presentation options. The first presentation option is a standard recency presentation mode. In this mode, posts are displayed in a list based on the recency with which they were contributed to. Thus, a new comment on an old post bumps it up to the top of the list. The second presentation option is a rankings-based presentation mode. In this mode, posts are displayed based on a mix of rankings of members contributing to the post and recency of contribution to the post. This is accomplished by first displaying all posts contributed to in the last hour, sorted by weighted average ranking of the contributing members, then displaying the remaining posts that have been contributed to in the last day, sorted by weighted average ranking of the contributing members, then displaying the posts last contributed to in the day before that sorted by rankings, and so on. The weighted average ranking of a post weights the post creator highest and members with more comments higher than members with less comments. After clicking on a post title, a member has the option to have comments on that post displayed by recency, by ranking of the contributing member, or by a combination of ranking and a rating of the individual comment by other members (resulting from tallying the explicit indications of approval/disapproval of the comment by the members).

The forum has many members and many rankings of the members for each other. Many members include demographic information in their profiles, including gender, age, location, occupation, and school attended, and some include further information such as likes and dislikes, experiences, etc. The forum has found that statistically, age and location are the greatest predictors of similarity in rankings between members. For example, members E and F are 20 years old and live in the South West, while member G is 60 years old and live in the North East. Members E and F are much more likely to have the same ranking of Member H than members E and G or F and G.

Members have the option of turning on default rankings. When this option is turned off, all otherwise unranked members are treated as having an average ranking (5.5). When the option is turned on, in the absence of a member's active or passive rankings (for example for new members who have not explicitly ranked other members or interacted with their contributed content), a default ranking is assigned based on the rankings of other members. If the age and location of a ranking member is not known, the other members are assigned a default ranking equal to their average ranking by all other members. If the age and location of the ranking member are known, the other members are assigned a default ranking equal to a weighted average of their rankings by other members, weighted based on similarity of the age and location of the other members to the ranking member. After the ranking member has accumulated active and passive rankings for various members, the weightings of other members' rankings that go into the default rankings change from similarity in age and location to similarity in active and passive rankings. In this way, the default rankings as accurately as possible reflect the active and passive rankings the members will ultimately be given by the ranking member. Default rankings continue to affect a member's effective ranking in a decreasing manner until a sufficient amount of active and/or passive ranking information have been received from the ranking member, thus making the effective ranking a combination of the default ranking, passive ranking, and/or active ranking.

The forum has a default ranking threshold of 1. Members with a ranking of 1 will not have their content (posts/comments) presented at all (to the members ranking them a 1). Members may personalize this threshold so that, for example, content from members with a ranking of 3 or below is not presented.

A new member I has not put in any profile information or ranked any members or interacted with any content. Default rankings of 3, 6, 7, and 8 are assigned to members J, K, L, and M, respectively, for member I, which are their average effective rankings by all members. Member I then inputs an age and location. The default rankings change to 4, 5, 7 and 9, respectively, as the members' rankings that make up the default rankings are weighted by similarity to I in age and location. I then actively ranks member J as a 9. J's effective ranking of I is 8.5, because the default ranking still affects the effective ranking I views a post submitted by member K, explicitly indicates disapproval of the post by selecting a “disapprove” button and navigates away from the post. Member K's passive ranking of member I is now 4. Member K's effective ranking for member I is 4.5 due to the influence of the default ranking Member I views and explicitly disapproves three more posts by member K. Member K's passive ranking is now 1. Given the four major passive ranking interactions, the default ranking no longer affects the effective ranking and member K's effective ranking for member I is also 1. Member I has not interacted with content submitted by member L, nor actively ranked member L. However, member K ranks member L a 9. Since member I ranks member K a 1, he is not likely to rank the same members highly as member K, therefore member I's passive ranking of member L is a 3. Members N, O and P also rank member J a 9, member K a 1, and member L a 3. Members N, O, and P also rank member M a 3. Since N, O, and P rank members similarly to I, their rankings are weighted more in generating member I's default ranking of member M, and the default ranking is adjusted from a 9 to a 7. Member I actively ranks member Q a 7. Member I then views a number of posts from Q and indicates explicit approval for the posts by selecting an “approval” button, comments on the posts and shares them with others. Member I's passive ranking of member Q is now 9. Member I's effective ranking of member Q is an 8, weighting the active ranking of 7 with the passive ranking of 9.

Thus, member I now has effectively ranked member J an 8.5, member K a 1, member L a 3, member M a 7 and member Q an 8. Members J, K, L, M and Q all submit posts within the same hour. These posts are presented to member I in the order 1) J's post 2) Q's post 3) M's post 4) L's post. K's post is not presented at all because K's ranking falls below the default threshold.

In some embodiments, members are able to obtain information about how they have been ranked by other members. In such embodiments, each member may not be able to determine the particular rankings of individual other members, but may have access to generalized ranking information and/or statistics, such as the member's average ranking among all other members, or among certain groups of other members, average ranking over time, affect on rankings of different pieces of content provided by the member, etc. Examples of statistics that may be available include average ranking of the member by males, by females, by other demographic groups, by other members having a particular average ranking or average ranking above a certain cutoff, by other members of a particular age or in a particular age range, by other members the member has ranked highly or within a certain range, etc. Statistics may be available regardless of whether passive ranking, active ranking, or a combination is used, and in the case of a combination, statistics for both passive and active rankings may be available. Such information and statistics may be displayed to members in an online community member profile, may be downloaded by members, and/or may be used to generate various reports and charts.

In addition, in another application the member may get these same statistics from a passive ranking system or a mix of an active and passive ranking system.

In the foregoing specification, embodiments have been described with reference to specific embodiments. However, one of ordinary skill in the art appreciates that various modifications and changes can be made without departing from the scope of the invention. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A method for presenting and prioritizing content on an online community, comprising:
receiving content configured to be presented on an online community over a network from members of the online community;
determining personalized rankings of the members of the online community for each other, including a first member's personalized rankings for each of a first group of members of the online community, wherein the personalized rankings reflect levels of interest in content produced by the ranked members; and
filtering and organizing the received content for distribution and presenting the content to each member based on each member's personalized rankings of the members from whom the content was received, including presenting the content to the first member based on the first member's personalized rankings of the first group of members of the online community, wherein content from members of the first group who are highly ranked by the first member is presented more prominently than other content.

2. The method of claim 1, wherein the first member's personalized rankings of each of the first group of members of the online community are based at least in part on an active ranking metric, the active ranking metric being an active metric entered by the first member on a graphical user interface associated with the online community for at least one of the first group of members of the online community.

3. The method of claim 1, wherein the first member's personalized rankings of each of the first group of members of the online community are based at least in part on a passive ranking metric, the passive ranking metric being associated with the first member's interactions with the content received from the first group of members of the online community.

4. The method of claim 1, further comprising:
receiving data associated with a ranking threshold from the first member, wherein the ranking threshold is associated with the first member's personalized rankings for each of the first group of members of the online community; and filtering out from presentation to the first member content from members having personalized rankings less than the ranking threshold.

5. The method of claim 1, wherein the first member's personalized rankings for a second group of members of the online community are based at least in part on personalized rankings of the first group of members for the second group of members.

6. The method of claim 3, wherein the first member's passive rankings for each of the first group of members are determined at least in part by indications of approval or disapproval of the first member for content submitted by the first group of members.

7. The method of claim 6, wherein the indications or approval or disapproval include explicit indications of approval and disapproval and implicit indications of approval and disapproval, wherein the implicit indications of approval include viewing, responding to, and sharing the content submitted by the first group of members and the implicit indications of disapproval comprise quickly navigating away from the content submitted by the first group of members after viewing and responding negatively to or ignoring the content submitted by the first group of members after viewing.

8. The method of claim 7, further comprising weighting the implicit indications of approval and disapproval according to their value in predicting active rankings of the members of the online community.

9. The method of claim 7, further comprising weighting the implicit indications of approval and disapproval according to their value in predicting active rankings of the members of the online community by new members of the online community and gradually shifting the weighting over time as the first member actively ranks the first group of members to weighting according to the value of the implicit indications of approval and disapproval in predicting active rankings of the first group of members of the online community by the first member.

10. The method of claim 7, further comprising weighting the implicit indications of approval and disapproval in calculating the first member's passive rankings according to their value in predicting active rankings of the first group of members of the online community by the first member.

11. The method of claim 6, further comprising decreasing an impact of the indications of approval or disapproval on the first member's passive rankings over time.

12. The method of claim 3, wherein the first member's passive rankings for the first group of members are determined at least in part by a frequency of the first member's interactions with the content received from the first group of members of the online community and a greater frequency results in a higher passive ranking.

13. The method of claim 3, wherein the first member's passive rankings for the first group of members are determined at least in part by rankings of the first group of members by a second group of members ranked by the first member, such that the first member's passive rankings of the first group of members are made to be more similar to the rankings of members of the second group of members ranked highly by the first member and less similar to the rankings of members of the second group of members ranked lowly by the first member.

14. The method of claim 1, further comprising assigning default personalized rankings of the first member for the first group of members before the first member has interacted with content received from the first group of members or explicitly ranked any of the first group of members, wherein the default rankings are determined at least in part by average rankings of the first group of members by the members of the online community.

15. The method of claim 1, wherein the first member's personalized rankings of the first group of members of the online community are based in part on an active ranking metric, the active ranking metric being an active metric entered by the first member on a graphical user interface associated with the online community for at least one of the first group of members of the online community, and in part on a passive ranking metric, the passive ranking metric being associated with the first member's interactions with the content received from the first group of members of the online community.

16. The method of claim 14, wherein the first member's personalized rankings of one or more of the first group of members are based in part on the assigned default rankings and in part on at least one of an active ranking metric entered by the first member on a graphical user interface associated with the online community and a passive ranking metric associated with the first member's interactions with the content received from the second group of members, after the first member has explicitly ranked and/or interacted with content received from at least one member of the second group of members.

17. The method of claim 14, wherein the average rankings of the first group of members by the members on the online community is a weighted average and the rankings of the members of the online community are weighted by similarity of each member to the first member in demographic characteristics.

18. The method of claim 17, further comprising determining the demographic characteristics used for the weighting based on the predictive value of the demographic characteristics for similarity of personalized rankings between two members.

19. The method of claim 14, wherein the average rankings of the first group of members by the members on the online community is a weighted average and further comprising weighting the rankings of the members of the online community by similarity of each member's rankings of a second group of members to the first member's rankings of the second group of members.

20. The method of claim 1, wherein the organizing content for distribution and presenting the content to the first member further comprises determining an amount of content that can be presented to the first user at a given time on a graphical user interface of the online community and presenting content of the highest-ranked members that meets any thresholds of the first member and fits within the determined amount of content.

21. The method of claim 1, further comprising displaying to the first member statistics relating to an average ranking of the first member by the members of the online community broken out by demographics and displaying an impact of different types and individual pieces of content submitted by the first member on the average ranking.

22. A system for prioritizing and personalizing content on an online community, comprising:
a communication device configured to receive content configured to be presented on an online community over a network from members of the online community;
one or more processing devices configured to execute computer program modules, the computer program modules comprising:
at least one of an active and a passive ranking module configured to determine personalized rankings of the members of the online community for each other, including a first member's personalized rankings for each of a first group of members of the online community, wherein the personalized rankings reflect levels of interest in content produced by the ranked members; and
a presentation module configured to filter and organize the received content for distribution and present the content to each member based on each member's personalized rankings of the members from whom the content was received, including to present the content to the first member based on the first member's personalized rankings of the first group of other members of the online community, wherein content from members of the first group who are highly ranked by the first member is presented more prominently than other content.
